(19) United States
(12) Patent Application Publication
(10) Pub. No.: US 2012/0298083 A1
(43) Pub. Date: Nov. 29, 2012

(54) TWO-STROKE HEAVY FUEL ENGINE

(75) Inventors: Thomas P. Howell, Ann Arbor, MI (US); Stephen R. Cakebread, Pleasant Ridge, MI (US); Todd W. Richardson, Ypsilanti, MI (US); Jeffrey M. Brueckheimer, Plymouth, MI (US)

(73) Assignee: RICARDO, INC., Van Buren Township, MI (US)

(21) Appl. No.: 13/113,419

(22) Filed: May 23, 2011

(51) Int. Cl. F02B 25/00

(52) U.S. Cl. 123/65 R

(57) ABSTRACT

A two-stroke internal combustion engine is provided. The two-stroke engine can be integrated into a variety of devices, including for example unmanned aerial vehicles, and can operate on heavy fuels including JP-5 and JP-8, for example. In some embodiments, engine can include a crankshaft including first and second main shaft portions interconnected by an offset crank web. The offset crank web can include opposing end portions that are offset from each other and define spaced apart centerlines generally perpendicular to and coplanar with the crankshaft centerline. In other embodiments, the engine can provide improvements in engine cooling, engine exhaust, lubrication delivery, engine mounting, engine fuel delivery and propeller attachment, for example.

### BACKGROUND OF THE INVENTION

The present invention relates to a two-stroke internal combustion engine for powering an unmanned aerial vehicle or other devices.

Two-stroke engines are identified apart from other engines based on their simplicity and relatively high power-to-weight ratios. For example, two-stroke engines possess fewer moving parts and can be produced at a lower cost when compared to their four-stroke counterparts. These and other advantages of the two-stroke engine can be attributed to the completion of each combustion cycle in half the number of working strokes and without the need for complicated valve assemblies, thereby reducing the engine size. As a result, two-stroke engines have gained widespread acceptance as an available power source for motorcycles, snowmobiles, outboard motors and other applications.

More recently, two-stroke engines have been suggested as a power source for unmanned aerial vehicles (UAVs). UAVs are increasingly used in operations requiring extending loiter times for surveillance and other mission objectives. However, many conventional two-stroke engines suffer from a number of shortcomings that can limit their acceptance as a power source for UAVs. For example, many existing two-stroke engines are designed to operate on conventional unleaded gasoline, which may be unavailable in certain operating environments. In addition, existing two-stroke engines can operate at unacceptably high decibel levels, which can compromise the UAV or force the UAV to higher altitudes outside of the range of onboard sensors. In addition, existing two-stroke engines can be otherwise poorly suited to meet the requirements for power, weight and fuel consumption for small, lightweight UAVs.

Accordingly, there remains a need for an improved engine for a UAV and other devices. In particular, there remains a need for an improved engine for a UAV that can leverage the benefits of two-stroke engines, including optionally low-costs, durability and high power-to-weight ratios.

### SUMMARY OF THE INVENTION

A two-stroke internal combustion engine is provided. The two-stroke engine can be used in combination with an unmanned aerial vehicle, and can operate on heavy fuels including JP-5 and JP-8, for example. The two-stroke engine can achieve size and mass savings over comparably powered engines, and can be adapted for use across a range of power settings and operating conditions.

In one embodiment, the two-stroke engine can include a crankshaft including first and second journaled end portions interconnected by an offset crank web. The first and second journaled end portions can each include a crankpin for connection to a corresponding connecting rod. The offset crank web can include first and second attachment arms disposed radially outward of each other and including an opening sized to receive a corresponding crankpin. The attachment arms can be offset from each other, defining spaced apart centerlines that intersect the crankshaft centerline. Optionally, the crankpins can be press-fit into the crank web openings and, should additional strength be desired, secured thereto by electron beam welding or other methods, including adhesives or arc welding for example.

In another embodiment, the two-stroke engine can include a cam-driven fuel pump. The fuel pump can include a plunger that is reciprocable within a plunger bore under the action of a cam lobe. The plunger and plunger bore can together define a pumping chamber in communication with a low pressure fuel reservoir and two or more fuel injectors. The cam-driven fuel pump can be positioned radially outward of the crankshaft and generally parallel to and offset from an adjacent cylinder. Each injector can disperse atomized fuel toward a piston during the compression stroke to cool the piston and to provide a distributed charging area.

In still another embodiment, the two-stroke engine can include a crankcase, a crankshaft rotatably supported by the crankcase, a starter/generator mounted about the crankshaft, and a starter/generator cover at least partially encapsulating the starter/generator. The starter/generator cover can include an annular sidewall and first and second support flanges extending radially outward from the annular sidewall. The support flanges can each define an aperture in alignment with a corresponding boss in the crankcase for receipt of an engine bolt. The starter/generator cover can be bolted to the crankcase to directly or indirectly retain the starter/generator in position about the crankshaft, and can include one or more apertures to allow the flow of air over the starter/generator.

In yet another embodiment, the two-stroke engine can include a lubrication system including a lubrication reservoir, an oil pump and a metering unit. The reservoir can supply oil to select areas of the engine, including the cam lobe, crankshaft bearing mounts, and left and right cylinders. The oil pump can be a pulsing electrical oil pump in fluid communication with the metering unit to accurately control the amount of oil supplied to the engine under a variety of running conditions. In some embodiments, the reservoir can be mounted over the engine centerline to minimize changes to the engine center-of-gravity with the depletion of engine oil while providing heat input to the oil.

In another embodiment, the two-stroke engine can include an exhaust system to selectively discharge exhaust gases through either of a muffler or an expansion chamber. The exhaust system can divert exhaust gases through the expansion chamber during high RPM engine settings such as take-off and high speed maneuvering, and can divert exhaust gases through the muffler when the associated airframe is operating at lower altitudes. In other embodiments, control of the exhaust flow path can be passively controlled, optionally in response to changes in the detected pressure altitude. In addition, the expansion pipe can be utilized as a structural member within the airframe, including a wing strut, a spar or a rib for example.

In still another embodiment, the two-stroke engine is air cooled. An associated airframe can include a cooling duct to divert outside air over the two-stroke engine. The cooling duct can include an inlet on a high pressure surface, for example a leading surface of the airframe, in fluid communication with an outlet on a lower pressure surface, for example an upper surface of the airframe. In some embodiments, the airframe upper surface can include a depression at the cooling duct outlet to further accelerate the flow of air through the cooling duct. The cooling duct can in some embodiments define a variable cross-section at one or more locations along its length. This cross-section can vary under the control of an Electronic Control Unit to maintain the cylinder head temperature within acceptable levels.

In still another embodiment, a propeller assembly is provided. The propeller assembly can include a propeller shaft joined to a propeller hub at a tapered interface. The propeller shaft can terminate with a tapered cone, and the propeller hub can include a funneled opening sized to receive the tapered cone therein, or be attached to a component with a funnel sized opening, for example, through a bolted joint. Each propeller blade root can be interposed between the propeller hub and an outboard washer, secured thereto by individual blade retaining bolts. A central retaining bolt can extend through the outboard washer along the propeller shaft centerline to urge the propeller hub into registration with the propeller shaft at the tapered interface.

Embodiments of the invention can therefore provide an improved two-stroke, heavy fuel engine for powering an unmanned aerial vehicle or other device. The two-stroke engine can have a reduced size and mass over existing two-stroke engines for low-cost integration into a variety of aerial surveillance platforms. The two-stroke engine can include improvements across a variety of systems, including for example engine cooling, engine exhaust, lubrication delivery, engine mounting, fuel delivery and propeller attachment. In addition, the two-stroke engine can provide cost savings by simplifying the installation, maintenance and repair of engine systems across a range of operating environments.

These and other advantages and features of the invention will be more fully understood and appreciated by reference to the description of the current embodiments and the drawings.

### BRIEF DESCRIPTION OF THE DRAWINGS

FIG. 1 is a rear perspective view of a crankcase for a heavy fuel engine.

FIG. 2 is a perspective view of a starter and crankshaft of the heavy fuel engine of FIG. 1

FIG. 3 is a vertical cross-sectional view of the crankcase of FIG. 1.

FIG. 4 is a front perspective view of the heavy fuel engine of FIG. 1 illustrating a crankcase and starter cover.

FIG. 5 is a rear perspective view illustrating a cam-driven fuel pump.

FIG. 6 is a horizontal cross-sectional view of the cam-driven fuel pump of FIG. 5.

FIG. 7 is a top view illustrating a crankshaft and connecting rods.

FIG. 8 is a rear perspective view illustrating front and rear counterweights.

FIG. 9 is a right side perspective view illustrating a cooling duct.

FIG. 10 is a perspective view illustrating an exhaust system for a heavy fuel engine.

FIG. 11 is a perspective view illustrating a lubrication system for a heavy fuel engine.

FIG. 12 is vertical cross-sectional view of an engine mount.

FIG. 13 is a rear perspective view illustrating a heavy fuel engine and a propeller assembly.

FIG. 14 is a vertical cross-sectional view of the propeller assembly of FIG. 13.

FIG. 15 is a perspective view illustrating integration of the heavy fuel engine and propeller assembly of FIGS. 1-14 into an unmanned aerial vehicle.

FIG. 16 is a horizontal cross-sectional view of the rear crankcase seal.

### DESCRIPTION OF THE CURRENT EMBODIMENTS

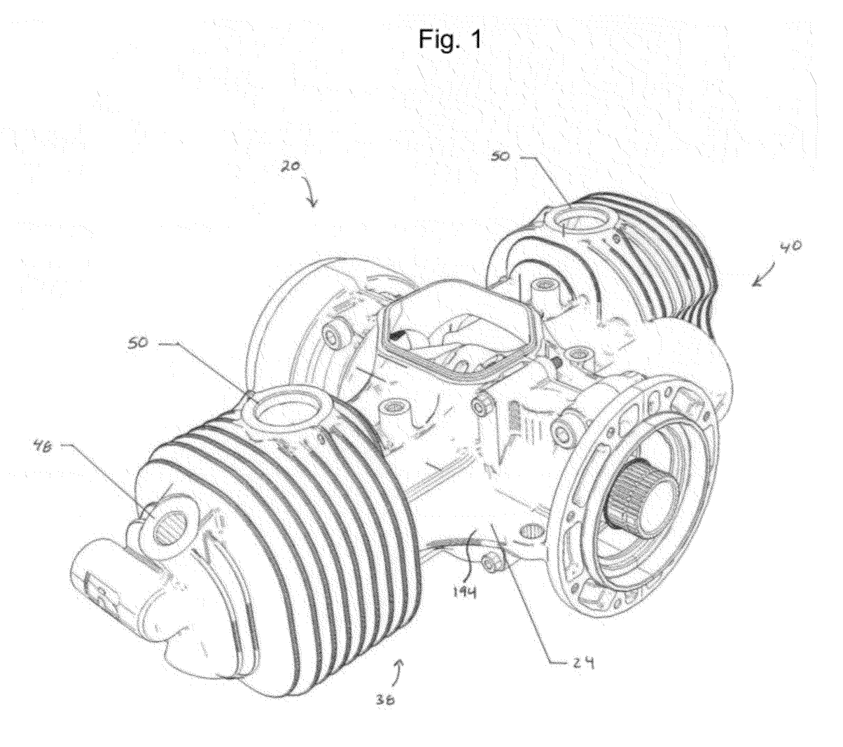

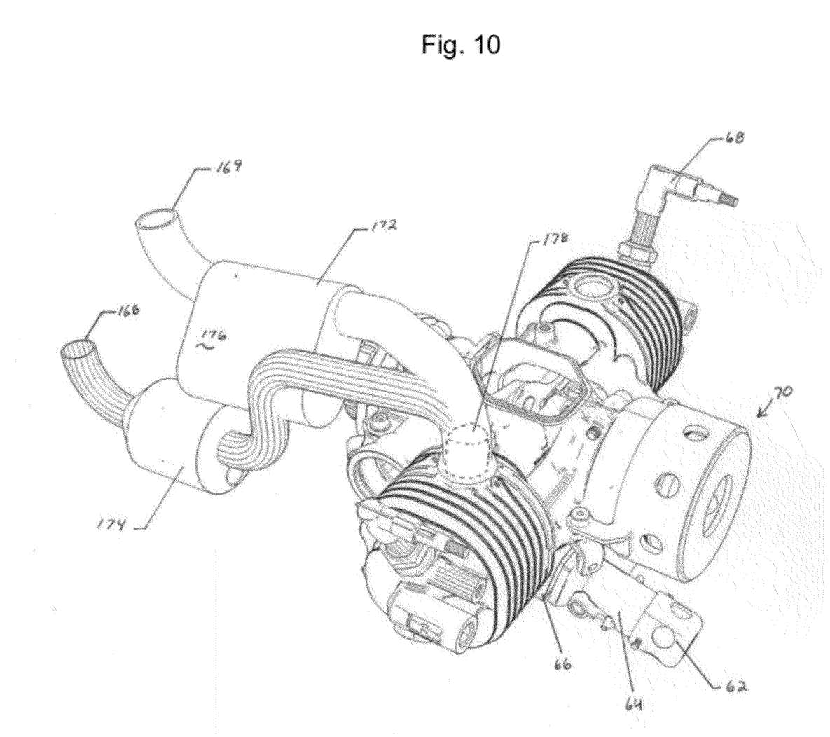

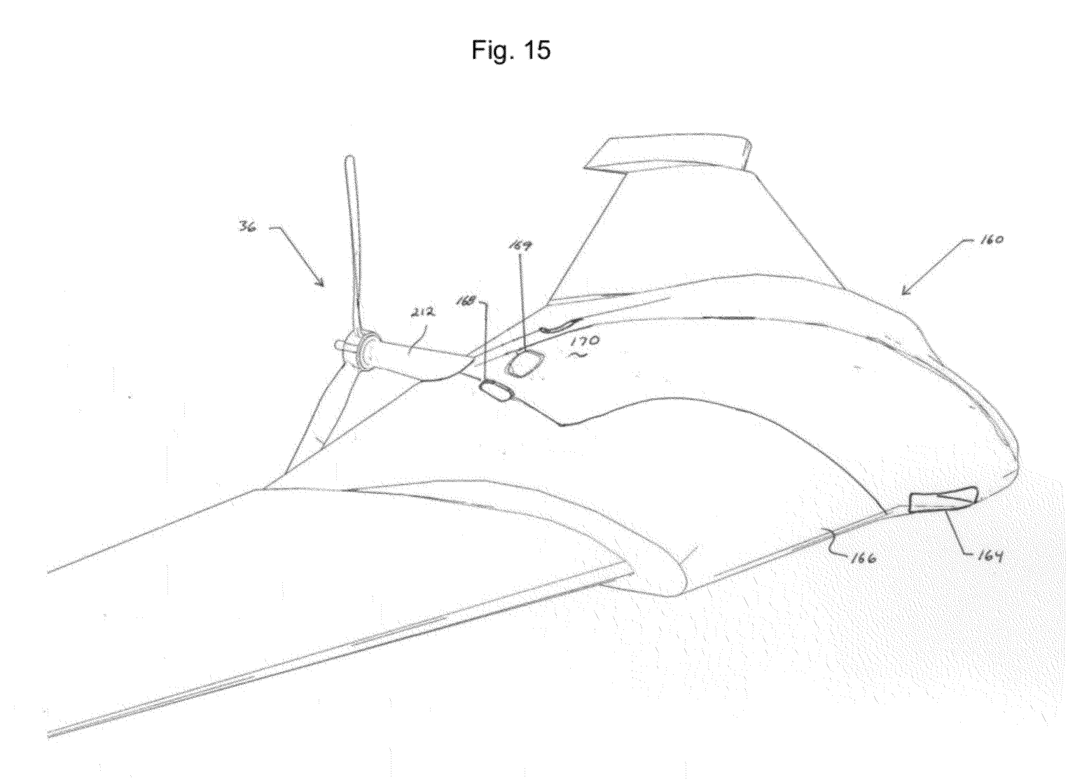

A heavy fuel engine in accordance with one embodiment of the present invention is shown in FIGS. 1-15 and generally designated 20. For illustrative purposes, the heavy fuel engine is described in connection with an unmanned aerial vehicle. It should be noted however that embodiments of the invention can be suitably adapted for use with a wide variety of systems, including watercraft, power tools and motorcycles for example, whether now known or hereinafter developed.

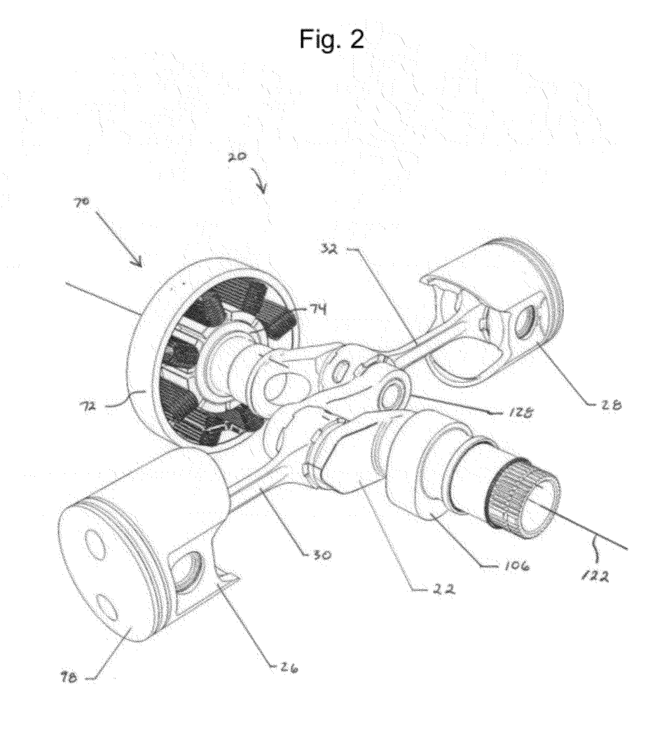

Referring now to FIGS. 1-2, the engine 20 includes a crankshaft 22 supported by a crankcase 24 and first and second pistons 26, 28 positioned laterally outward of the crankshaft 22. Connecting rods 30, 32 transform linear motion of the pistons 26, 28 into a rotary motion of the crankshaft 22. The crankshaft 22 is operatively engaged to a propeller shaft 34, which can be equipped with a propeller 36 adapted to provide a moving force through a fluid, such as air or water. In addition, the engine 20 can be air cooled, achieving a smaller size and mass over comparably powered liquid cooled engines. As explained below, the engine 20 can operate on a heavy fuel, otherwise usually applied in aviation for operating gas-turbine engines. Suitable fuel types can be sold, for example, under the trade names JP-5, JP-8 or Jet A-1, for example. An optional amount of lubricating oil and/or other additives, for example a synthetic two-stroke oil, can also be added to the selected fuel.

As also shown in FIGS. 1-3, the crankcase can include laterally opposed cylinders 38, 40 each including a cylinder head 42 mounted to a corresponding cylinder wall 44. Each piston 26, 28 is received within a corresponding cylinder 38, 40 for movement alternatively through a compression stroke and a working stroke. The cylinder head 42 can include a fuel injector opening 46 and one or more spark generator openings 48 disposed through a generally conical cylinder head 42. The cylinder wall 44 can define an exhaust port 50, side transfer ports 52, 54, and a rear boost port 56 opposite the exhaust port 50. The fuel injector opening 46 allows the flow of fuel generally perpendicularly to pre-combusted air entering the cylinder from the boost port 56. As explained below, fuel can be supplied to left- and right-side fuel injectors 58 by a common fuel line under pressure from a fuel pump 60.

In operation, pre-combusted air is drawn into the crankcase 24 during each compression stroke through an air filter 62, a throttle body 64 and a reed valve 66 mounted on the underside of the engine 20. When the piston 26 reaches the bottom of a working stroke, compressed air in the crankcase 24 is diverted around the piston 26 through the transfer ports 52, 54 and into the cylinder 38. The pre-combusted air from the transfer ports 52, 54 and also from the boost port 56 fills the cylinder 38, forcing the exhaust gases from the cylinder 38 through the exhaust port 50. During this portion of the compression stroke, fuel is injected into the cylinder 38 and the resulting fuel-air mixture is further compressed and finally ignited by an ignition spark at the spark generator opening 48. In each compression stroke, the piston 26 compresses the fuel-air mixture into the cylinder 38, while at the same time drawing pre-combusted air into the crankcase 24 through reed valve 66, for example a two-petal reed valve 66. In each successive working stroke, spent fuel exits through the exhaust port 50, while pre-combusted air in the crankcase 24 is forced into the cylinder 38 for compression by the piston 26 and ignition by a spark plug 68. The compression stroke and working stroke repeat themselves, generating torque on the crankshaft 22 to power rotation of the propeller 36.

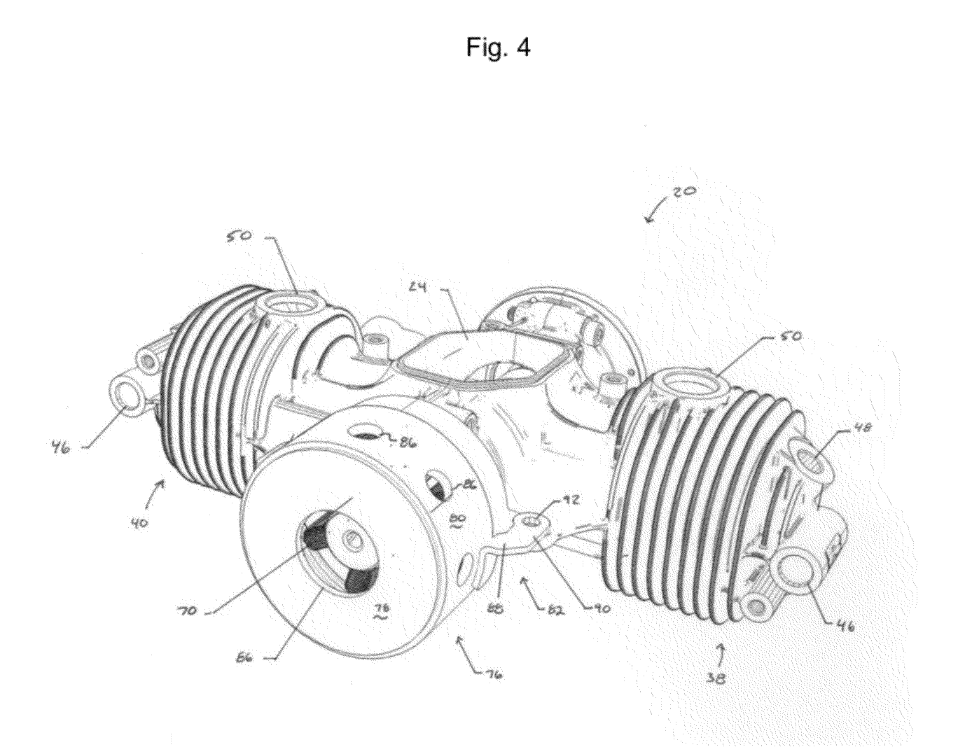

Referring now to FIGS. 2 and 4, the engine 20 includes an integrated starter generator (ISG) 70 mounted on the forwardmost portion of the crankshaft 22 opposite the propeller 36. The ISG 70 can include a stator 72 fixedly mounted to the crankcase 24, a concentric rotor 74 fixedly mounted about the crankshaft 22, and a starter cover 76 at least partially encapsulating the ISG stator 72 and rotor 74. The starter cover 76 can include an end cap 78, an outer annular sidewall 80, and first and second support flanges 82, 84 extending radially outward from the sidewall 80. The end cap 78 and sidewall 80 can each include one or more apertures 86 to allow the flow of air through the starter cover 76 to cool the ISG 70. The support flanges 82, 84 can each include a radial portion 88 and an axial portion 90. The axial portion 90 can define a bore 92 into which an engine mount bolt 94 can be screwed to join the starter cover 76, and thus the ISG 70, to an abutting portion of the crankcase 24. That is, the starter cover 76 can fit snugly over the ISG 70 and can be bolted onto the crankcase 24 to directly or indirectly hold the rotor 74 and stator 72 in place axially and to hold the crankshaft oil seal in place. The ISG 70 can optionally define a longitudinal centerline that is an extension of the longitudinal centerline 122 of the crankshaft 22. The support flanges 82, 84 can be integrally formed with the sidewall 80 or can be welded to the sidewall 80, for example. In the present embodiment, the ISG is a generator with a power output of up to 500 W that can rotate the engine at up to 1500 RPMs, while in other embodiments the ISG can be selected to provide power outside of these parameters.

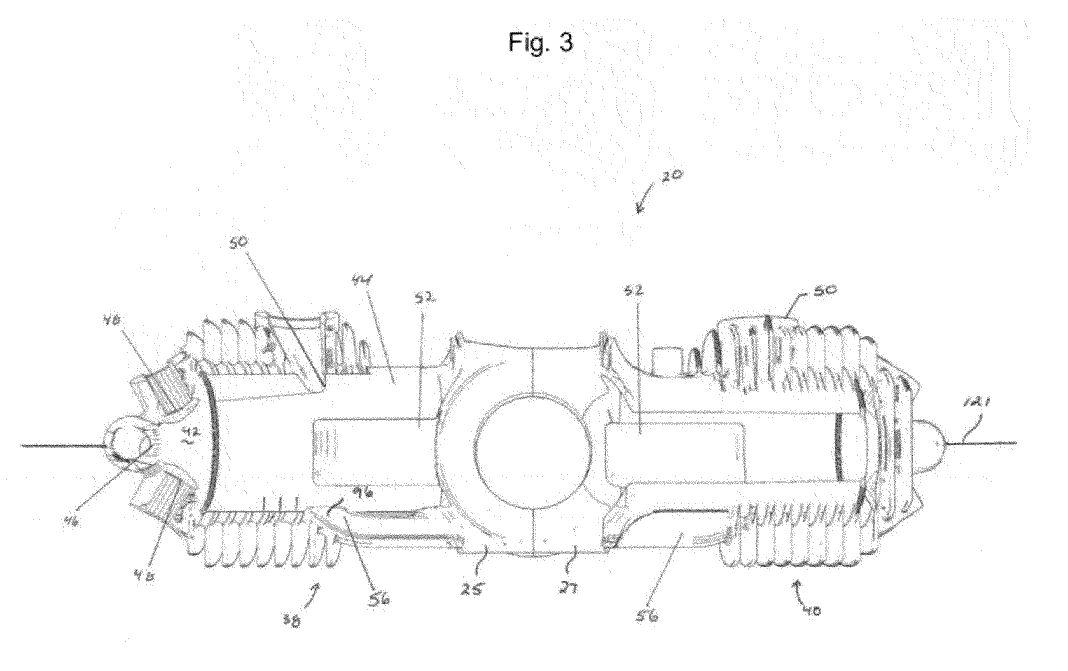

As noted above, the crankcase 24 can include boost ports 56 for directing pre-combusted air into the cylinders 38, 40. The boost ports 56 can increase the availability of pre-combusted air for improved scavenging performance and assistance in atomizing the injected fuel and thus increase the power output of each working stroke with a corresponding increase in fuel flow from the injector 58. As shown in the vertical cross-sectional view of FIG. 3, the boost ports 56 can include a zero-degree draft angle to improve the flow path of pre-combusted air into the cylinders 38, 40. That is, each boost port 56 can extend along a substantial portion of its length in a direction generally parallel to the cylinder longitudinal centerline 121 before terminating in a gradually curved portion 96. Optionally, the top edges of the boost port 56, the transfer ports 52, 54 and/or the exhaust port 50 are disposed in the same vertical plane. In addition, investment castings can be utilized to fabricate the boost ports 56, optionally using soluble cores. According to one manufacturing process, for example, a wax pattern can be shaped to match the boost port and then invested (i.e., coated) with particular ceramic materials to build up a ceramic shell mold with a desired thickness. That is, the boost port cavity can be formed using one or more ceramic cores which can be disposed of in place. When the wax pattern is subsequently removed from the ceramic shell mold, the ceramic core can remain in place to form the boost port 56. After metal casting is complete, the ceramic core can be removed or dissolved from the cast crankcase 24. Optionally, the ceramic core can be removed by forming the core from a material that is soluble in water or caustic alkali, for example.

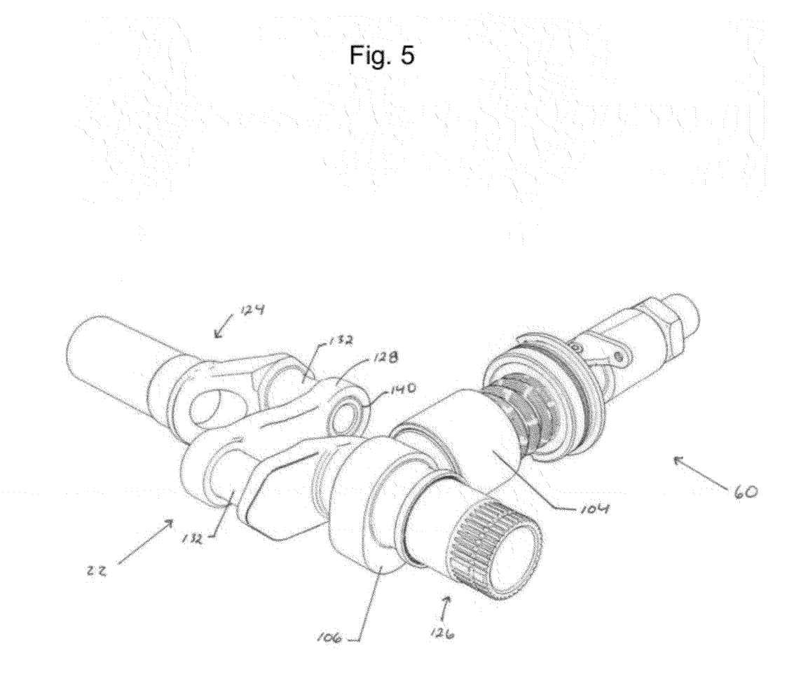

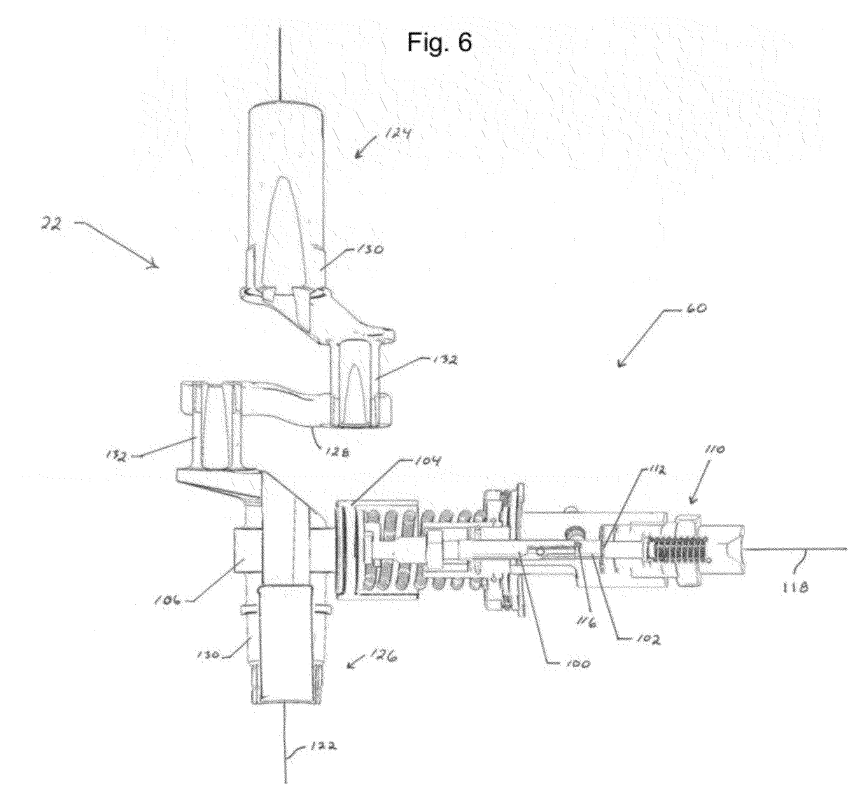

Referring now to FIGS. 5-6, the engine 20 can further include a cam-driven fuel pump 60 to operate both injectors 58 simultaneously. For example, the cam-driven fuel pump 60 can include a plunger 100 which is reciprocable within a plunger bore 102 under the action of a sliding tippet 104 and crankshaft-mounted cam-lobe 106. The pump plunger 100 and the pump bore 102 together define a pumping chamber 108 in communication with a check valve 110 through an outlet port 112 and in communication with a low pressure fuel reservoir 114 through a feed port 116. Optionally, the check valve 110 is spring-biased to permit fuel flow towards the injectors 58 at an unrestricted rate while also restricting the flow of fuel in a reverse direction. In the illustrated embodiment, the cam-driven fuel pump 60 is positioned laterally outward of the crankshaft 22 and defines a longitudinal centerline 118 generally parallel to and offset from a cylinder centerline 121, while in other embodiments the fuel pump 60 may include a variety of alternative configurations. Each fuel injector 58 can inject an atomized mist of heavy fuel in a direction orthogonal to the injected air, minimizing the pre-combusted discharge of fuel through the exhaust port 50. The injected fuel optionally impinges the piston crown 98 during each compression stroke, which can be used as supplementary cooling for the piston 26 while also providing a distributed charging area that burns quickly and smoothly without unwanted knocking or detonation. The fuel injectors 58 can each be activated separately as a function of the operating conditions of the engine 20. For example, the operating conditions of the engine, such as throttle opening or engine speed, can dictate the amount of fuel injected by the injectors 58 during each injection cycle.

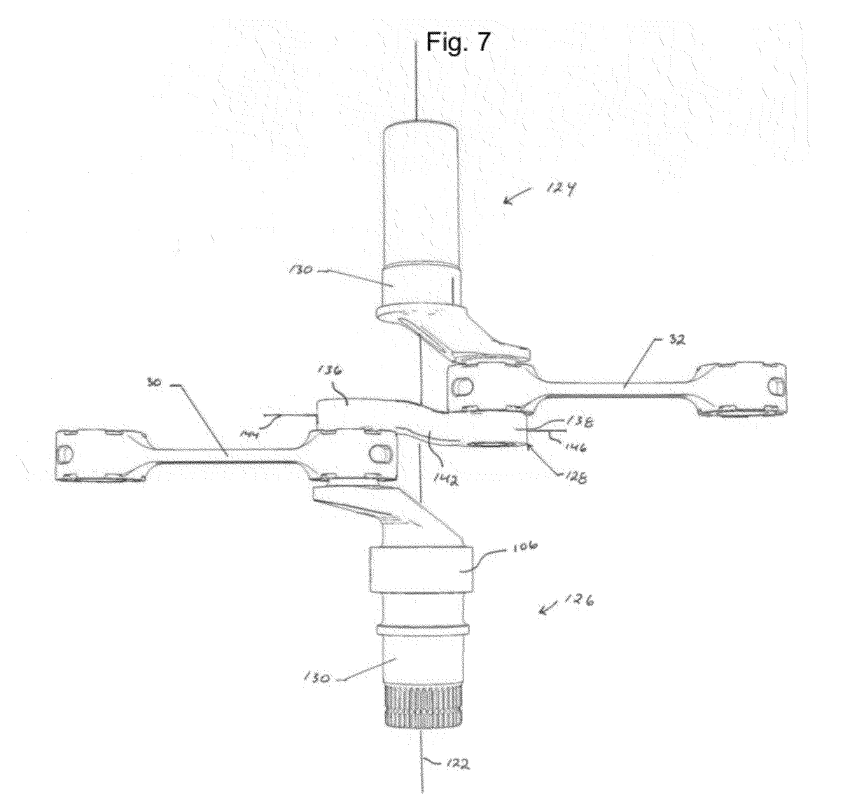

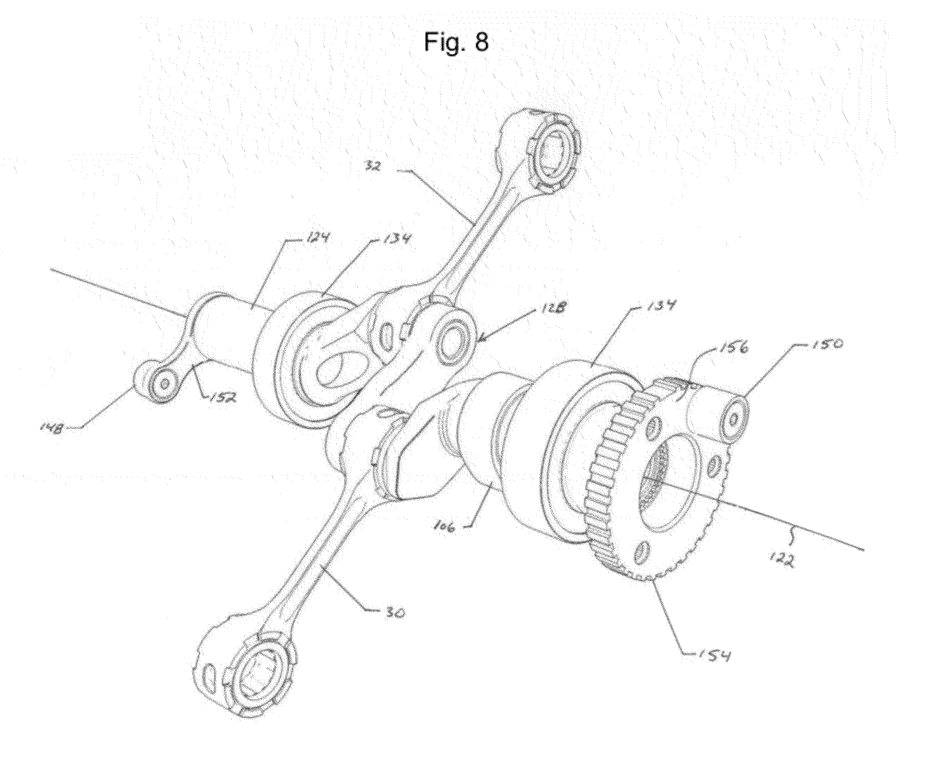

As also shown in FIGS. 5-6, the crankshaft 22 can include first and second journaled end portions 124, 126 interconnected by an offset crank web 128. The first and second end portions 124, 126 each include a journaled end 130 and a crankpin 132. As shown in FIGS. 7-8, the journaled end 130 can be supported for rotation by bearings within a cylindrically shaped bearing mount 134 in the crankcase 24. The crankpins 132 can be positioned radially outward of the crankshaft centerline 122 and can each be connected to a corresponding connecting rod 30, 32. As shown, the offset crank web 128 can include first and second attachment arms 136, 138 disposed radially outward of each other, each attachment arm 136, 138 including an opening 140 sized to receive a corresponding crankpin 132. To reduce the length of the crankshaft 122, the attachment arms 136, 138 can be axially offset from each other, being interconnected by a slightly “S” shaped or curved middle portion 142 when viewed from above as shown in FIG. 7. For example, the attachment arms 136, 138 define spaced apart centerlines 144, 146 that intersect the crankshaft centerline 122. The crank web 128 can be pre-formed separately from the first and second end portions 124, 126 and fixed thereto by pressing the crankpins 132 into a corresponding crank web opening 140. After the crankpins 132 are press-fit into the crank web 128, the crankpins 132 can be bonded to the crank web 128 according to any suitable technique, including for example electron beam welding.

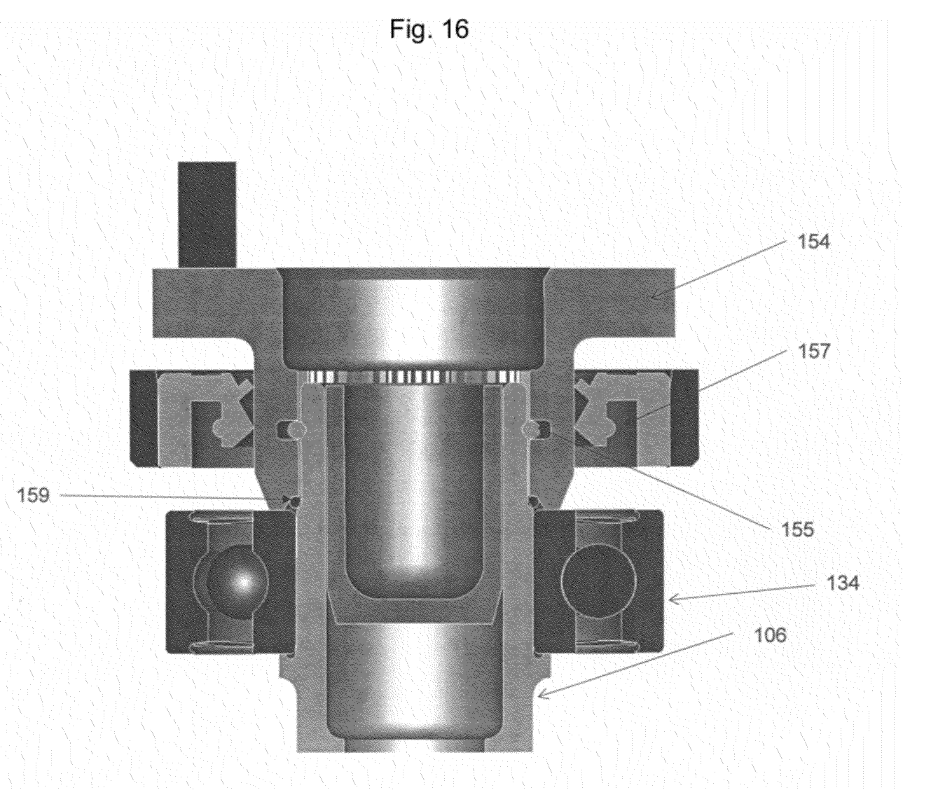

The engine 20 can include front and/or rear counterweights 148, 150 to achieve a balanced crankshaft rotation. As shown in FIG. 8, the front counterweight 148 can extend radially outward of the crankshaft 22, being optionally supported by a web 152 joined to the first crankshaft end portion 124. By locating the front counterweight 148 radially outward of the crankshaft centerline 122, the mass of the front counterweight 148 can be reduced in a corresponding manner. The web 152 and front counterweight 148 can be positioned within the starter cover 76, optionally cooling the ISG 70 by promoting the flow of air through the cover openings 86 toward the ISG 70. In addition, the ISG rotor 74 can optionally be used in combination with a multi-pole electrical device as a back-up crankshaft position sensor. As also shown in FIG. 8, the rear counterweight 150 is supported by a toothed crankshaft flange 154 adjacent the rear bearing mounts 134. The crankshaft flange 154 can be splined and can include a single missing tooth from the outer radial surface for engagement with a circlip 155. As shown in FIG. 16, the oil seal 157 can contact radially on the outer surface of the crankshaft flange 154 allowing for service access to the rear bearing mount 134. The crankshaft flange axially contacts the inner race of the rear bearing mount 134, providing a direct path for thrust force from the propeller into the crankcase 24, while leakage is prevented by the use of an o-ring 159 that contacts the crankshaft 126, crankshaft flange 154 and rear bearing mount 134. The rear counterweight 150 can be supported by a rear-facing axial surface 156 of the flange 158, and can be positioned radially outward of the crankshaft centerline 122. The front and rear counterweights 148, 150 can be formed of a high-density material, for example a tungsten alloy such as Densimet® by Plansee GmbH of Austria. The front and rear counterweights 148, 150 can collectively balance or counteract the cam lobe 106 for operating the high-pressure fuel pump 60. Alternatively, the crankshaft 22 and/or the cam lobe 106 can be balanced by removing material from the web 152 or the crankshaft flange 156, for example.

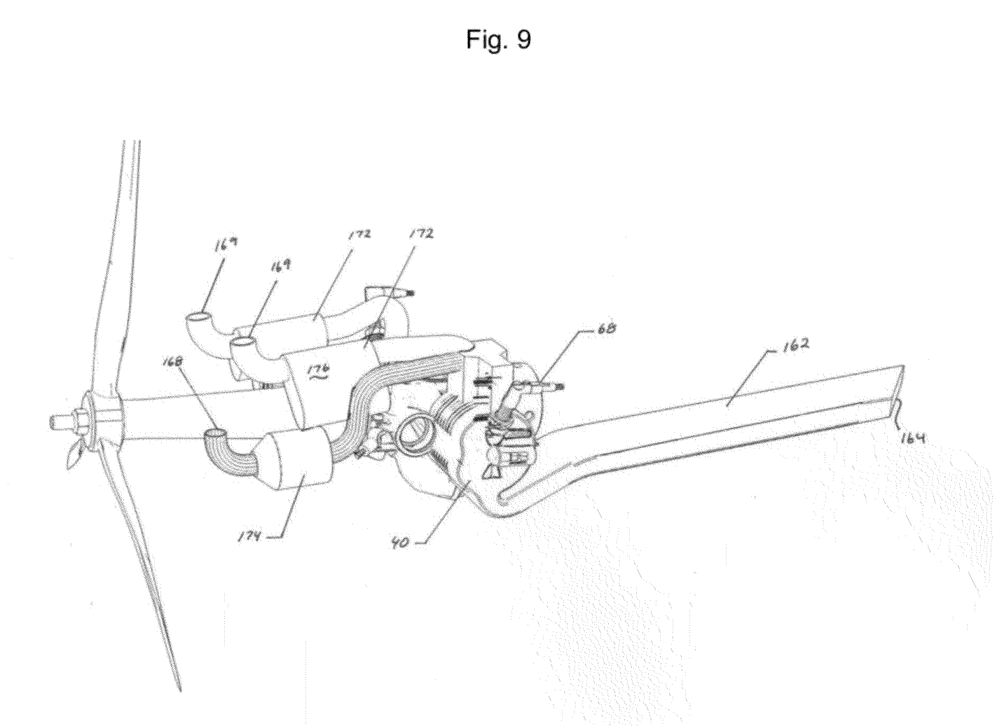

As noted above, the engine 20 can be air cooled to achieve a smaller size and mass over comparably powered liquid cooled engines. As shown in FIG. 9 for example, a supporting airframe 160 can include one or more cooling ducts 162 to divert airflow over the crankcase 24. In particular, a single cooling duct 162 can divert airflow generally upward over the right cylinder 40. While only the right cooling duct 162 is shown, it will be appreciated that the left cooling duct can be included in a corresponding manner, or a common entry on the aircraft surface can be accommodated prior to the common duct splitting into separate ducts with a separate duct dedicated to each cylinder. Optionally, the left and right cooling ducts 162 can each include an inlet 164 on a leading surface 166 of the supporting airframe 160 in fluid communication with one or more outlets 168, 169 on an upper surface 170 of the airframe 160, optionally through an expansion chamber 174 and/or muffler 176 as explained below. The stagnation pressure at the inlet 164 and the negative pressure over the outlets 168, 169 cooperate to promote the flow of air over the left and right cylinders 38, 40. In some embodiments, the airframe upper surface 170 can include a depression at the cooling duct outlets 168, 169 to further accelerate the flow of air through the cooling ducts 162. Further optionally, each cooling duct 162 can define a variable cross-section at one or more locations along its length. This cross-section, and consequently the volume flow rate of ambient air over each cylinder 38, 40, can vary based on a variety of factors. For example, the cooling duct inlet 164 can vary in size based on the cylinder heat temperature. In this configuration, an electronic control unit (ECU) or other controller can increase the flow of air over the cylinders 38, 40 as a cylinder head temperature exceeds a threshold temperature. The ECU can likewise decrease the flow of air over the cylinder 38, 40 as a cylinder head temperature falls sufficiently below the threshold temperature. In this example of a closed loop feedback system, the ECU can therefore actively regulate the flow of air through the cooling ducts 162 based on cylinder head temperatures and/or other factors.

As noted above, exhaust gases are released from the cylinders 38, 40 at the end of each working stroke through respective exhaust ports 50. In one embodiment, these exhaust gases are selectively diverted to the exterior of the airframe 160 through either of a muffler 172 or a tuned expansion pipe 174. For example, the exhaust gases can be diverted through respective mufflers 172 for quieter operation of the engine 20 or through respective expansion pipes 174 for a more fuel efficient operation of the engine 20. The mufflers 172 can include any device adapted to modify or attenuate the sound output of the engine 20. For example, the mufflers 172 can each include an absorptive material within a casing 176 to disperse and absorb acoustic energy. In addition, the expansion pipes 174 can each include an inlet pipe, a divergent section, a convergent section, and an outlet pipe. The expansion pipes 174 can be tuned for performance across a range of running conditions, including for example high RPM engine settings during take-offs and high-speed maneuvering. In addition, the expansion pipe 174 can be utilized as a structural member within the airframe 160, including a wing strut, a spar or a rib for example. Although shown as including a muffler 172 in combination with an expansion pipe 174, the engine 20 can in some embodiments include only the muffler(s) 172 or the expansion pipe(s) 174, but not both. In still other embodiments the engine 20 can include neither exhaust component, particularly for lightweight airframes having a smaller size and/or a smaller available gross weight.

In one embodiment, control of the exhaust flow path can be actively controlled. For example, the ECU can divert exhaust air through the expansion pipes 174 at altitudes where un-modified engine noise is negligible to persons on the ground. Still by example, the ECU can divert exhaust air through the mufflers 172 when the airframe is at lower altitudes and remains otherwise undetected to persons on the ground. The ECU can divert the flow of exhaust air to the mufflers 172 or to the expansion pipes 174 through a valve 178, for example a solenoid valve, in fluid communication with the exhaust port 50. In another embodiment, however, control of the exhaust flow path can be passively controlled. For example, the flow path can switch between the mufflers 172 and the expansion pipes 174 based on the pressure difference between the exhaust gases at the exhaust port 50 or the exhaust outlets 168, 169 and the static pressure at a given operating altitude as measured by a static pressure port. As the pressure difference increases above a threshold value, indicating a drop in static pressure and a corresponding increase in pressure altitude, the flow path can switch from the mufflers 172 to the expansion pipes 174. As the pressure difference returns to nominal levels, the flow path can revert back to the mufflers 172.

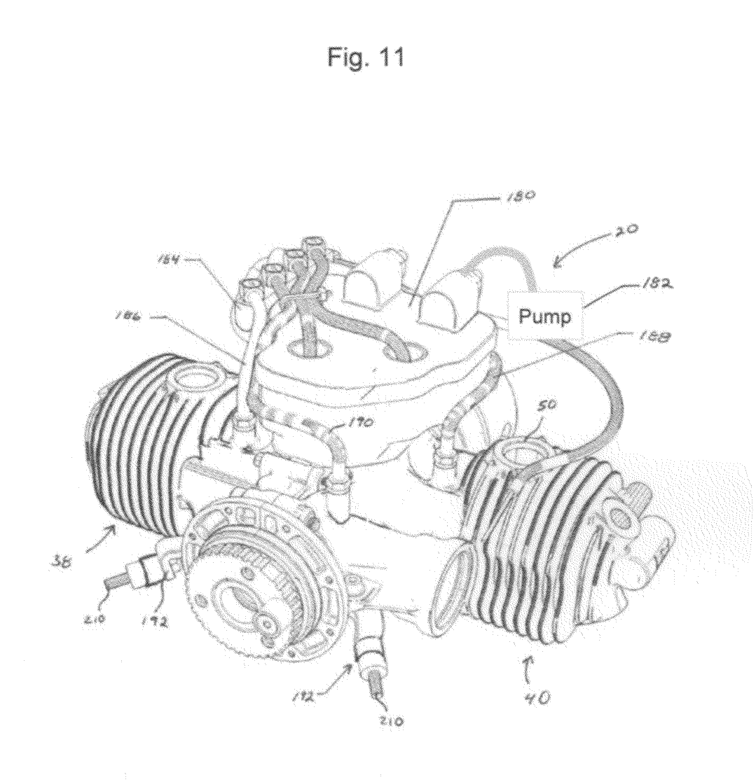

Referring now to FIG. 11, the engine 20 can also include a lubrication system for delivering oil to the engine 20. In the present embodiment, the lubrication system is adapted to lubricate select areas of the engine 20, for example the cam lobe 106, the bearing mounts 134 and the cylinder bores 38, 40 before burning off excess oil for discharge with other exhaust gases. The lubricating system can include a lubrication reservoir 180, an associated oil pump 182 and an oil metering unit 184. The lubrication reservoir 180 can be mounted over the engine centerline 122 to minimize changes to the engine center-of-gravity with the depletion of engine oil. As shown, the lubricating reservoir 180 supplies oil to the crankcase 24 through respective left-side, ride-side and rear conduits 186, 188, 190. These conduits 186, 188, 190 supply lubricating oil to the left and right cylinders 38, 40, the bearing mounts 134, the cam lobe 106 and optionally other engine components through individual lubricant passages in the crankcase 24. Optionally, the lubricant passages can terminate in a spray nozzle to more effectively lubricate the left and right cylinders 38, 40, the bearing mounts 134 and the cam lobe 106. In addition, the oil pump 182 can be an external oil pump driven under the control of the ECU. In the present embodiment, the oil pump 182 is a pulsing electrical oil pump while in other embodiments the oil pump 182 is mechanically driven. The metering unit 184 can be in fluid communication with the oil reservoir 180 and optionally the oil pump 182 to accurately control the amount of oil supplied to the engine 20 under a variety of running conditions.

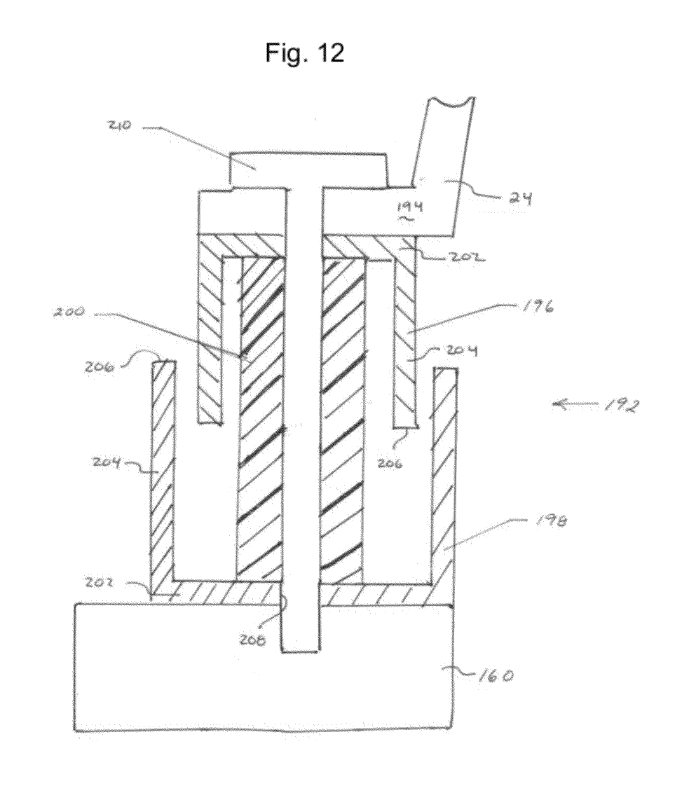

As illustrated in FIGS. 4-5 above, the crankcase 24 can include left and right crankcase portions 25, 27. The mating surfaces of the two crankcase portions, when assembled, can lie in the same vertical plane that passes through the crankshaft centerline 122. In order to dampen engine vibrations, the engine 20 can include resilient engine mounts 192 to secure the crankcase 24 to the airframe 160. For example, four engine mounts 192 can extend downwardly from respective crankcase webs 194 in the present embodiment, while in other embodiments additional or fewer engine mounts can be utilized. In the present embodiment, each engine mount 192 includes first and second concentric sleeve displacement limiters 196, 198 that open toward one another, the displacement limiters 196, 198 being vertically spaced apart by a resilient dampener 200. The displacement limiters 196, 198 can be formed of any suitable material, for example a steel alloy. Each displacement limiter 196 can include a cylindrical body including a base 202 and an annular sidewall extending from the base 204 and terminating at a periphery 206. The base 202 can include an aperture 208 sized to receive a bolt 210 or other fastener which passes through the crankcase web 194, the engine mount 192 and the airframe 160. As also shown in FIG. 12, the displacement limiter sidewalls 204 can at least partially overlap and can be laterally spaced apart to limit lateral movement of each respective engine mount 192. The dampener 200 can be formed of any suitable material, for example a resilient rubber material. In addition, the dampener 200 can be generally cylindrical, defining a vertical dimension less than the combined height of the inner and outer displacement sleeve sidewalls 204 such that the sidewalls 204 at least partially overlap as noted above. Accordingly, the open ended displacement limiters 196, 198 effectively capture the resilient dampener 200 and can prevent or reduce the risk of sheering.

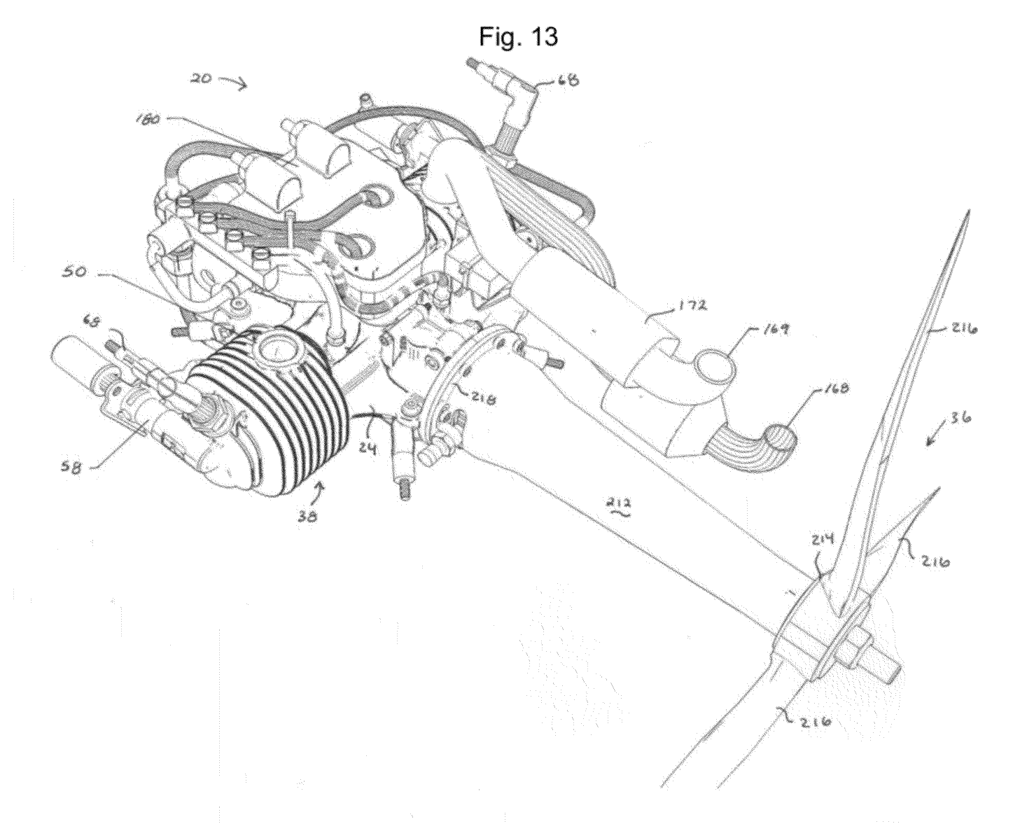

Referring now to FIGS. 13-15, the crankshaft 22 is operatively engaged to a propeller assembly 36 to provide a moving force through a fluid. The propeller assembly can include a housing 212, a propeller shaft 34, a propeller hub 214 and two or more propeller blades 216 extending radially outward from the propeller hub 214. The housing 212 can include a flange 218 defining multiple threaded through-holes 220 corresponding to multiple threaded bosses 222 in the crankcase 24. The housing 212 can also include a sidewall 224 that is tapered along a substantial portion of its length before terminating at periphery 226. The propeller shaft 34 can extend between the crankshaft 22 and the propeller hub 214, being received within and spaced apart from the housing sidewall 224. The propeller hub 214 can in turn be mounted to the propeller shaft 34 and can carry each propeller blade 216 at its base 228 for rotation about the shaft centerline 229, optionally an extension of the crankshaft centerline 122.

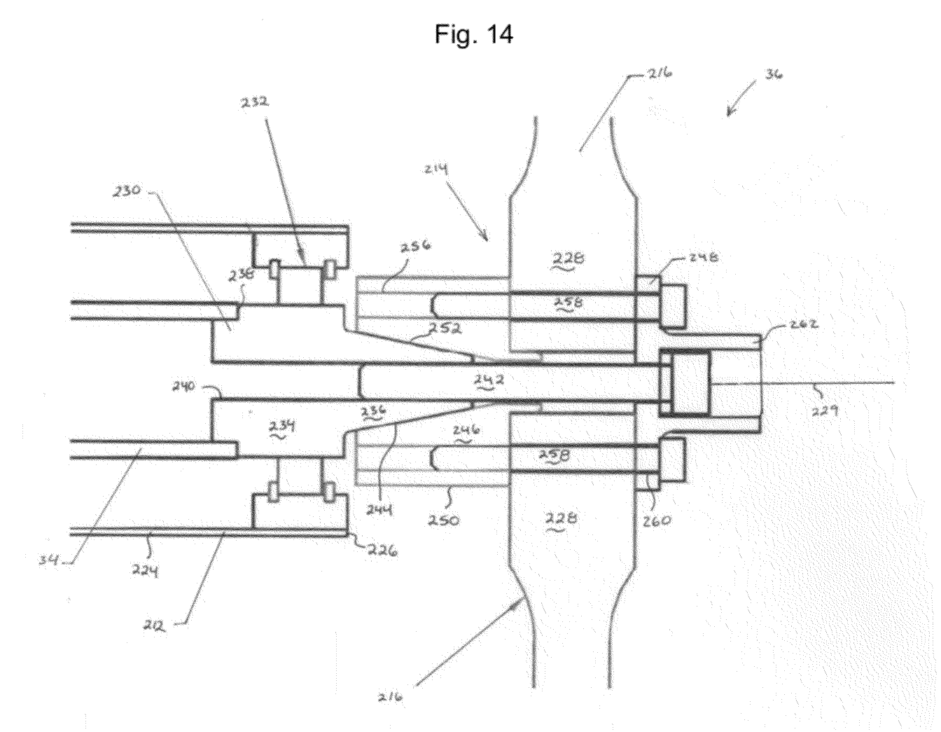

As perhaps best shown in FIG. 14, the propeller shaft 34 can be coupled to a tapered joint 230 rotatably supported by a bearing mount 232 in the propeller housing 212. The tapered joint 230 can include a main body portion 234 and a conical portion 236. The main body portion 234 can be generally cylindrical and housed within the propeller housing 212. In addition, the main body portion 234 can define an outer annular recess 238 sized to be press-fit and optionally bonded into the propeller shaft 34 according to any suitable technique, including for example arc welding, such that rotation of the propeller shaft 34 results in a corresponding rotation of the tapered joint 230. The conical portion 236 can converge at a threaded opening 240 sized to receive a central retaining bolt 242, and can extend beyond the propeller housing 212. In some embodiments, the threaded opening 240 extends partially through the tapered joint 230, while in the present embodiment the threaded opening 240 extends completely through the tapered joint 230, opening into the interior of the propeller shaft 34.

The propeller hub 214 can be joined to the tapered joint 230 at a conical interface 244 and can include a tapered flange 246 and an outboard washer 248. As shown in FIG. 14, the base of each propeller 228 can be interposed between the spaced apart flange 246 and outboard washer 248. The tapered flange 246 can include an outer annular surface 250 and a funneled opening 252 shaped to closely correspond to the exterior of the tapered joint 230, substantially encompassing the conical portion 236. The funneled opening 252 can terminate in a threaded central bore 254 sized to accommodate the central retaining bolt 242. The tapered flange 246 can further include a threaded boss 256 radially outward of the propeller shaft centerline 122 for receipt of a corresponding retaining bolt 258.

The outboard washer 248 can define a primary through-hole for the central retaining bolt 242 and multiple secondary through-holes 260 radially outward of the axis of rotation 122. The outboard washer 248 can urge the base of the propeller blades 228 into engagement with the tapered flange 246, which is urged into engagement with the tapered joint 230, which is press-fit into the propeller shaft 34. The tapered interface between the tapered joint 230 and the tapered flange 246 can facilitate a self-centering propeller hub 214 to maintain balance during flight. The outboard washer 248 can further include a raised hexagonal sidewall 262 adapted for engagement by a suitable driving implement, particularly if the ISG 70 is not utilized. The propeller hub 214 the propeller shaft 34 and propeller blades 216 can be formed of any suitable material, including for example lightweight carbon fiber materials to reduce the overall weight of the propeller assembly 36. The minimal use of fasteners as noted above can in some embodiments facilitate servicing and manufacturing of the propeller assembly without significant propeller mass.

In the assembly of the above embodiments, it should be noted that adhesives can be used in place of conventional retention members to reduce the size and weight of the overall engine 20. For example, the intake assembly 270—including the air filter 62, the throttle body 64, and reed valve 66 for example—can be joined to each other and to the crankcase 22 using a system of lap joints and an adhesive. In some embodiments, the left and right crankcase halves 25, 27 can be bonded together using an adhesive, while in other embodiments the crankcase halves 25, 27 can be held together using a system of flanges and threaded fasteners. In addition, while the above features are described in combination in a single heavy fuel two-stroke engine, the above features may be included individually or collectively in a wide variety of systems, including gasoline engines, four-stroke engines, rotary engines or “V” engines, for example.

The above descriptions are those of the current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A crankshaft for a two-stroke engine comprising:
first and second journaled end portions defining an axis of rotation; and
a crank web interconnecting the first and second journaled end portions, the crank web including first and second attachment arms axially offset from each other and coupled to respective first and second end portions.

2. The crankshaft of claim 1 wherein the first and second end portions are electron beam welded to the offset crank web.

3. The crankshaft of claim 1 wherein the first and second end portions include first and second crankpins, respectively.

4. The crankshaft of claim 3 wherein the first and second attachment arms of the crank web define respective first and second centerlines being parallel to and offset from each other to increase the axial alignment of the first and second crankpins.

5. The crankshaft of claim 3 wherein the first and second attachment arms of the crank web define first and second spaced apart centerlines being parallel to and offset from each other and intersecting the axis of rotation.

6. The crankshaft of claim 1 further including first and second counterweights supported by the first and second end portions, respectively, the first and second counterweights disposed radially outward of the crankshaft axis of rotation.

7. The crankshaft of claim 1 further including a flange rotatably supported by one of the first and second journaled end portions, the flange being asymmetrical with respect to the axis of rotation through the removal of a portion of the flange to balance rotation of the crankshaft.

8. A two-stroke internal combustion engine comprising:
first and second fuel injectors;
a crankshaft defining a cam lobe; and
a fuel pump including pump housing and a plunger that is reciprocable within the pump housing under the action of the cam lobe to provide fuel to the first and second fuel injectors substantially simultaneously.

9. The two-stroke engine of claim 8 further including first and second pistons each including a crown, the first and second fuel injectors each being adapted to disperse an atomized mist of fuel toward the first and second piston crowns, respectively.

10. The two-stroke engine of claim 9 further including a lubrication system including a lubrication reservoir for retaining a lubricating fluid, the lubrication system being adapted to disperse the lubricating fluid toward the cam lobe.

11. The two-stroke engine of claim 10 further including first and second bearing mounts for rotatably supporting the crankshaft, the lubrication system being further adapted to disperse the lubricating fluid toward the first and second bearing mounts.

12. The two-stroke engine of claim 9 further including first and second cylinders each defining a boost port, the boost ports being investment cast molded.

13. The two-stroke engine of claim 9 further including:
first and second cylinders each defining a cylinder head temperature; and
first and second cooling ducts adapted to vary the flow of ambient air over the respective first and second cylinders based on the corresponding cylinder head temperature.

14. An engine comprising:
a crankcase defining an engine mount through-hole;
a crankshaft rotatably supported by the crankcase;
a starter/generator including a rotor supported by the crankshaft; and
a cover at least partially encapsulating the starter/generator, the cover including a support flange defining an aperture in alignment with the engine mount through-hole.

15. The engine of claim 14 wherein the starter/generator cover includes an annular sidewall, the support flange extending outwardly from the sidewall.

16. The engine of claim 14 wherein the starter/generator cover includes a base defining an opening to permit the flow of air over the starter/generator.

17. The engine of claim 14 further including an engine mount in alignment with the engine mount through-hole, the engine mount including first and second cylindrical end caps being spaced apart by a resilient dampener.

18. The engine of claim 17 wherein the first and second end caps each include an axially extending sidewall to at least partially circumferentiate the resilient dampener.

19. The engine of claim 18 wherein the axially extending sidewalls at least partially overlap each other to impede lateral movement of the engine mount.

20. An exhaust system for an engine having an exhaust port, comprising:
a first exhaust chamber to improve the volumetric efficiency of the engine;
a second exhaust chamber to attenuate the sound output of the engine; and
a valve adapted to selectively provide fluid communication between the exhaust port and one of the first and second exhaust chambers.

21. The exhaust system of claim 20 wherein the first exhaust chamber is an expansion pipe.

22. The exhaust system of claim 20 wherein the second exhaust chamber is a muffler.

23. The exhaust system of claim 21 wherein the expansion pipe is an internal structural support for an airframe.

24. The exhaust system of claim 23 wherein the structural support includes one of a wing strut, a spar and a rib.

25. The exhaust system of claim 20 wherein the valve is in a first open state in fluid communication with the first exhaust chamber and a second open state in fluid communication with the second exhaust chamber.

26. The exhaust system of claim 25 further including a controller to actively actuate between the first and second open states.

27. A propeller assembly comprising:
a propeller shaft including a tapered end portion; and
a propeller hub defining a conical opening sized to receive the tapered end portion therein.

28. The propeller assembly of claim 27 wherein the propeller shaft and the propeller hub each define an aperture sized to receive a central retaining bolt.

29. The propeller assembly of claim 27 further including an outboard washer and at least one propeller blade, the outboard washer and the propeller hub being axially spaced apart by the at least one propeller blade.

30. The propeller assembly of claim 29 wherein the outboard washer defines an aperture sized to receive the central retaining bolt to urge the propeller hub into registration with the tapered end portion of the propeller shaft.
